(19) United States
(12) Patent Application Publication
(10) Pub. No.: US 2025/0136224 A1
(43) Pub. Date: May 1, 2025

(54) A SYSTEM TO OPERATE VOICE CONTROL FOR A VEHICLE AND A METHOD THEREOF

(71) Applicant: TVS MOTOR COMPANY LIMITED, Chennai (IN)

(72) Inventors: Avinash Gullyal, Chennai (IN); Valavanur Umasankar Kalpana, Chennai (IN); Dipanjan Mazumdar, Chennai (IN)

(73) Assignee: TVS MOTOR COMPANY LIMITED, Chennai (IN)

(21) Appl. No.: 18/835,649

(22) PCT Filed: Nov. 29, 2022
(86) PCT No.: PCT/IN2022/051042

§ 371 Date: Aug. 2, 2024

(30) Foreign Application Priority Data
Feb. 2, 2022 (IN) 202241005674

(51) Int. Cl. B62J 50/21; B62J 45/20; G10L 15/22

(52) U.S. Cl. CPC B62J 50/21; B62J 45/20; G10L 15/22; G10L 2015/223

(57) ABSTRACT

A system to operate voice control for a vehicle includes: a switch; a control unit operatively coupled to the switch, the control unit having a communication module; and a safety gear having a voice input module. The voice input module is configured to communicate with the communication module. The voice input module receives voice input from a rider and establishes communication with the communication module when the switch is actuated. The switch is configured to be actuated in one or more positions by the rider, the switch based on the position of actuation generates a corresponding electric signal.

### FIELD OF THE INVENTION

The present invention generally relates to a system to operate voice control for a vehicle and a method thereof.

### BACKGROUND OF THE INVENTION

Vehicles are increasingly incorporating newer and sophisticated technologies and features to improve inter alia, performance, rider comfort and safety. However, vehicles have an inherent space constraint in accommodating various switches or operation element for each and every feature. Such constraint increases in case of a saddle type vehicles wherein, all switches must be provided on a handlebar assembly for the rider to operate.

In the known art, voice control is provided in the vehicle to assist a rider in operating a multitude of features. However, turning ON the voice control and turning the same OFF would require yet another additional button on a dashboard or the handlebar assembly of the vehicle. And in case, a turning ON and OFF means is absent, the voice control would be perpetually ON. As a result, besides the rider's voice commands, a lot of noise from the environment would be captured leading to an increased response time of the processor. Further, the rider's privacy is at risk of being compromised if any personal or sensitive information gets disclosed in the public owning to the voice control feature being ON at all times.

Thus, there is a need in the art for a system to operate voice control for a vehicle and a method thereof which can address at least the aforementioned problems and limitations.

### SUMMARY OF THE INVENTION

In one aspect, the present invention is directed to a system to operate voice control for a vehicle including a switch, a control unit having a communication module and a safety gear having a voice input module. The control unit is operatively coupled to the switch. The voice input module of the safety gear is configured to communicate with the communication module. The voice input module is further configured to receive voice input from a rider and establish communication with the communication module when the switch is actuated.

In an embodiment, the switch is configured to be actuated in one or more positions and based on the position of actuation generate a corresponding electric signal.

In an embodiment, the one or more positions in which the switch can be actuated are forward, rear, left, right in a vehicle front-rear direction and centre.

In an embodiment, the switch is configured to generate an electric signal for activating voice control when operated in the centre position for a first predetermined time.

In an embodiment, the switch is configured to generate an electric signal for deactivating voice control when operated again in the centre position for the first predetermined time.

In an embodiment, the control unit is configured to deactivate voice control when the switch is not operated for a second predetermined time.

In an embodiment, the control unit is configured to deactivate voice control when the voice control is not used for a third predetermined time.

In an embodiment, the switch is configured to generate an electric signal corresponding to a plurality of functions such as accepting or rejecting incoming phone calls, changing volume or pausing music, navigating a screen installed in the vehicle and viewing stored documents in a storage device of the vehicle when operated in the forward, rear, left, right positions in a vehicle front-rear direction.

In an embodiment, the control unit is configured to perform a predetermined function based on the corresponding electric signal generated by the switch.

In an embodiment, the vehicle is a saddle type vehicle having the switch mounted on a handlebar of the saddle type vehicle.

In an embodiment, the safety gear comprises a helmet to be worn by the rider.

In an embodiment, the communication module and the voice input module communicate over a wireless network.

In an embodiment, the system includes a display unit in communication with the control unit, the display unit configured to display a status upon activation of voice control.

In another aspect, the present invention is directed to a method for operating voice control for a vehicle. The method includes the steps of: actuating a switch; generating an electric signal by the switch; receiving the electric signal by a control unit; and establishing communication between a communication module of the control unit and a voice input module disposed in a safety gear.

In an embodiment, the method includes the step of receiving an electric signal by the control unit corresponding to a position of the switch, the switch being configured to be actuated in forward, rear, left, right in a vehicle front-rear direction and centre positions.

In an embodiment, the method includes the step of generating an electric signal by the switch for activating voice control when operated in the centre position for a first predetermined time.

In an embodiment, the method includes the step of generating an electric signal by the switch for deactivating voice control when the switch is again operated in the centre position for the first predetermined time.

In an embodiment, the method includes the step of deactivating, by the control unit, voice control when the switch is not operated for a second predetermined time.

In an embodiment, the method includes the step of deactivating, by the control unit, voice control when the voice control is not used for a third predetermined time.

In an embodiment, the method includes the step of generating an electric signal by the switch corresponding to a plurality of functions such as accepting or rejecting incoming phone calls, changing volume or pausing music, navigating a screen installed in the vehicle and viewing stored documents in a storage device of the vehicle when operated in the forward, rear, left, right positions in a vehicle front-rear direction.

In an embodiment, the method includes the step of displaying a status upon activation of voice control by a display unit, the display unit being in communication with the control unit.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 illustrates a system to operate voice control for a vehicle, in accordance with an embodiment of the present invention.

FIG. 2 illustrates a switch, in accordance with an embodiment of the present invention.

FIG. 3 illustrates the switch, in accordance with an embodiment of the present invention.

FIG. 4 illustrates the switch, in accordance with an embodiment of the present invention.

FIG. 5 illustrates a method to operate voice control for a vehicle, in accordance with an embodiment of the present invention.

FIG. 6 illustrates a method to activate voice control of a vehicle, in accordance with an embodiment of the present invention.

FIG. 7 illustrates a method to deactivate voice control of a vehicle, in accordance with an embodiment of the present invention.

### DETAILED DESCRIPTION OF THE INVENTION

Various features and embodiments of the present invention here will be discernible from the following further description thereof, set out hereunder.

The present invention generally relates to a system to operate voice control for a vehicle and a method thereof.

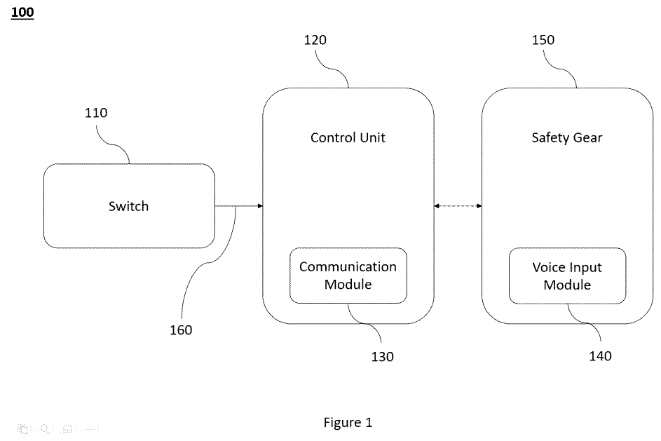

FIG. 1 illustrates a system 100 to operate voice control for a vehicle, in accordance with an exemplary embodiment of the present invention. As illustrated, the system 100 comprises a switch 110, a control unit 120 and a safety gear 150. In an embodiment, the vehicle incorporating the system 100 is a saddle type vehicle. Further, the switch 110 is mounted on a handlebar (not shown) of the saddle type vehicle. The control unit 120 further comprises a communication module 130. The safety gear 150 further comprises a voice input module 140. In an embodiment, the safety gear 150 comprises a helmet to be worn by the rider and the voice input module 140 is disposed inside the helmet. The control unit 120 and the switch 110 are operatively coupled to each other, the control unit 120 being configured to receive electric signals from the switch 110. The communication module 130 in the control unit 120 establishes communication with the voice input module 140 in the safety gear 150 over a wireless network. In an embodiment, the wireless network is provided through Bluetooth.

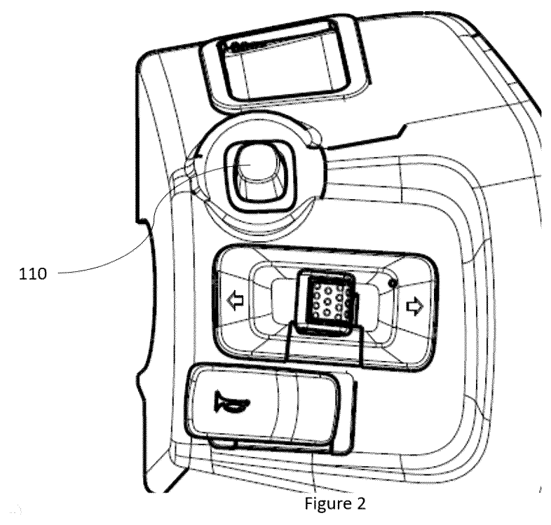

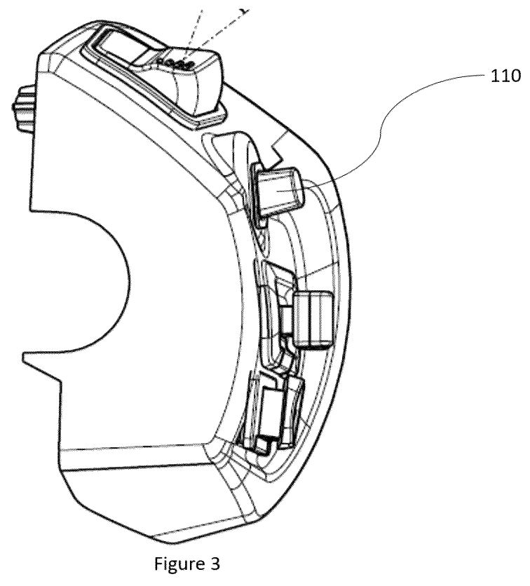

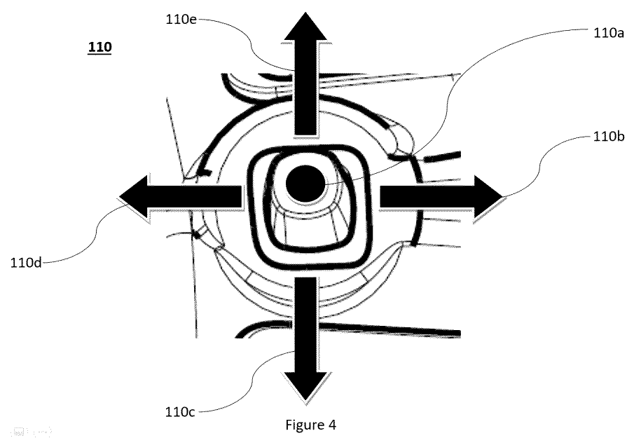

FIGS. 2 to 4 illustrate the switch 110, in accordance with an embodiment of the present invention. Referring to FIG. 4, the switch 110 is configured to be actuated in one or more positions 110a, 110b, 110c, 110d, 110e by the rider. The said positions include forward 110e, rear 110c, left 110d, right 110b positions in a vehicle front-rear direction and centre 110a position. The one or more positions 110a, 110b, 110c, 110d, 110e of the switch 110 correspond to a different function. In an embodiment, the switch 110 is a joystick capable of being actuated in a plurality of directions. The switch 110 based on the position of actuation, generates a corresponding electric signal 160. The corresponding electric signal 160 is transmitted to the control unit 120 of the system 100.

In an embodiment, the switch 110 is configured to generate an electric signal 160 for activating voice control when operated in the centre position 110a for a first predetermined time. On actuation of the switch 110 in the centre position for a first predetermined time, the electric signal 160 is transmitted to the control unit 120. On receiving the electric signal 160, the communication module 130 in the control unit 120 communicates with the voice input module 140 in the safety gear 150 over the wireless network and enables voice control whereby, the rider can provide vocal instructions or queries as desired.

Upon delivery of vocal instructions or queries as desired, the rider may deactivate voice control through the system 100. The switch 110 is configured to generate an electric signal 160 for deactivating voice control when operated in the centre position 110a for a second predetermined time. On actuation of the switch 110 in the centre position for a second predetermined time, the electric signal 160 is transmitted to the control unit 120. On receiving the electric signal 160, the communication module 130 in the control unit 120 terminates communication with the voice input module 140 in the safety gear 150.

In an embodiment, the switch 110 is configured to generate an electric signal 160 corresponding to a plurality of functions such as accepting or rejecting incoming phone calls, changing volume or pausing music, navigating a screen installed in the vehicle and viewing stored documents in a storage device of the vehicle when operated in the forward 110e, rear 110c, left 110d, right 110b positions in a vehicle front-rear direction. Further, the switch 110 can be actuated in centre 110a position standalone to operate a function besides being actuated for a predetermined time to operate voice control for the vehicle.

In another embodiment, the system 100 comprises a display unit (not shown) in communication with the control unit 120. The display unit is provided in an instrument cluster (not shown) of the saddle type vehicle. The display unit is configured to display a status upon activation of voice control by the system 100.

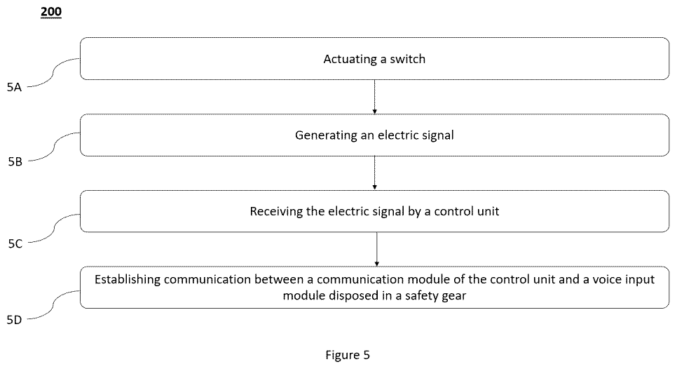

FIG. 5 illustrates a method 200 to operate voice control for a vehicle, in accordance with an exemplary embodiment of the present invention. As illustrated, the method 200 comprises step 5A, actuating the switch 110. The switch 110 can be actuated by a rider of the vehicle. At step 5B, an electric signal 160 is generated upon actuation of the switch 110. At step 5C, the electric signal 160 is received by the control unit 120. At step 5D, communication is established between the communication module 130 of the control unit 120 and the voice input module 140 disposed in the safety gear 150.

In an embodiment, the method 200 includes the step of receiving an electric signal 160 by the control unit 120 corresponding to a position of the switch 110, the switch 110 being configured to be actuated in forward 110e, rear 110c, left 110d, right 110b in a vehicle front-rear direction and centre 110a positions.

The method 200 includes the step of generating an electric signal 160 by the switch 110 for activating voice control when operated in the centre position 110a for a first predetermined time. Further, the method 200 includes the step of generating an electric signal 160 by the switch 110 for deactivating voice control when operated again in the centre position 110a for the same first predetermined time. The control unit 120 deactivates voice control when the switch 110 is not operated for a second predetermined time. The control unit 120 deactivates voice control when no voice input has been obtained from the rider for a third predetermined time.

In an instance, the first predetermined time is about two seconds, the second predetermined time is about one minute, and the third predetermined time is about one minute.

In an embodiment, the method 200 includes the step of generating an electric signal 160 by the switch 110 corresponding to a plurality of functions such as accepting or rejecting incoming phone calls, changing volume or pausing music, navigating a screen installed in the vehicle and viewing stored documents in a storage device of the vehicle when operated in the forward 110e, rear 110c, left 110d, right 110b positions in a vehicle front-rear direction.

In an embodiment, the method 200 includes a step of displaying a status upon activation of voice control by a display unit, the display unit being in communication with the control unit 120.

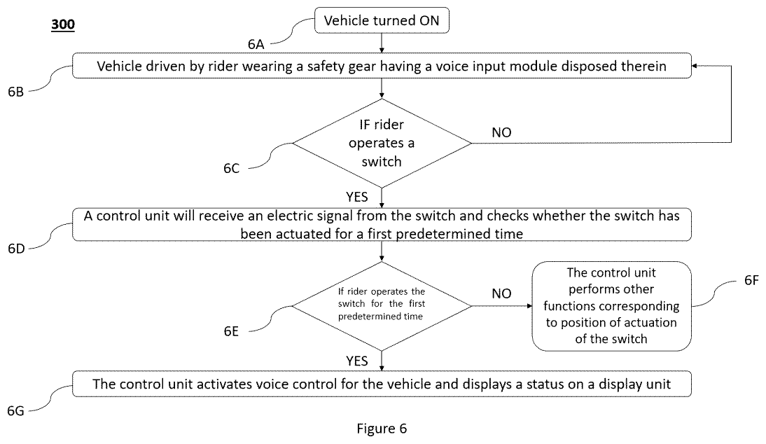

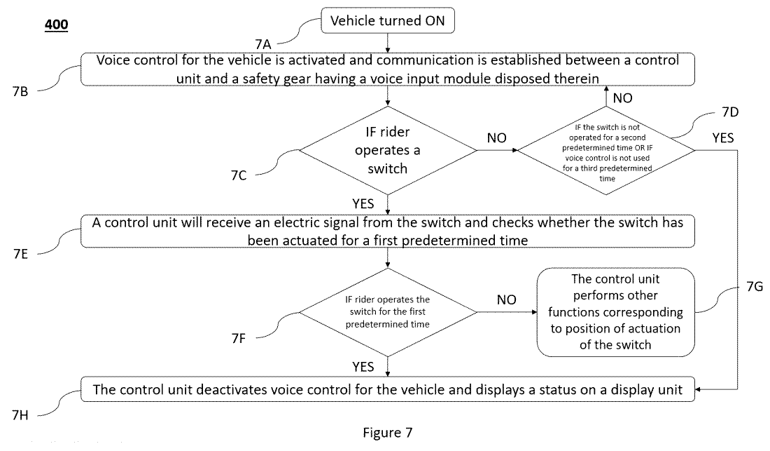

FIGS. 6 and 7 illustrate exemplary embodiments of the method 200 to activate and deactivate voice control for a vehicle respectively. As illustrated in FIG. 6, the method 300 includes a step 6A in which the vehicle is turned ON. The vehicle, in step 6B, is being driven by the rider wearing the safety gear 150 having the voice input module 140 disposed therein. At step 6C, the control unit 120 determines whether the rider has actuated the switch 110. At step 6D, the switch 110 upon actuation sends an electric signal 160 to the control unit 120. The control unit 120 is configured to determine, at step 6E, whether the switch 110 has been operated for the first predetermined time. When the switch 110 has been actuated in the centre position 110a for the first predetermined time, the control unit 120, at step 6G, activates voice control and further display a status on the display unit. When the switch 110 has been actuated in forward 110e, rear 110c, left 110d, right 110b in a vehicle front-rear direction and centre 110a positions, the control unit 120, at step 6F, performs a function corresponding to the position of actuation of the switch 110.

As illustrated in FIG. 7, the method 400 includes the vehicle being turned ON at step 7A. The voice control is activated at step 7B and the communication module 130 of the control unit 120 is in communication with the voice input module 140 disposed in the safety gear 150. At step 7C, the control unit 120 determines whether the rider has operated the switch 110. The switch 110 upon actuation sends an electric signal 160, at step 7E, to the control unit 120. At step 7F, the control unit 120 determines whether the switch 110 has been operated for the first predetermined time. When the switch 110 has been actuated in the centre position 110a for the first predetermined time, the control unit 120, at step 7H, deactivates voice control and further display a status on the display unit. When the switch 110 has been actuated in forward 110e, rear 110c, left 110d, right 110b in a vehicle front-rear direction and centre 110a positions, the control unit 120, at step 7G, is configured to perform a function corresponding to the position of actuation of the switch 110. At step 7D, the control unit deactivates voice control when the switch 110 is not operated for a second predetermined time. Further, at step 7D, the control unit deactivates voice control when no voice input has been obtained from the rider for a third predetermined time.

Advantageously, the system to operate voice control can be activated when a swich is actuated in the centre push position for a first predetermined time and the switch is capable of performing a plurality of different functions when actuated in different positions. Further, the system can be deactivated when the switch is actuated in the centre push position for a second predetermined period thus eliminating any risk of compromising privacy of the rider. Accordingly, the present invention can effectively eliminate the necessity of a standalone, separate switch for operating voice control.

While the present invention has been described with respect to certain embodiments, it will be apparent to those skilled in the art that various changes and modification may be made without departing from the scope of the invention as defined in the following claims.

1-21. (canceled)

22. A system to operate voice control for a vehicle, comprising:
a switch;
a control unit operatively coupled to the switch, the control unit having a communication module; and
a safety gear having a voice input module, the voice input module configured to communicate with the communication module, wherein
the voice input module receives voice input from a rider and establishes communication with the communication module when the switch is actuated, and
the switch is configured to be actuated in one or more positions by the rider, the switch based on the position of actuation generates a corresponding electric signal.

23. The system as claimed in claim 22, wherein
the one or more positions in which the switch can be actuated are forward, rear, left, right in a vehicle front-rear direction and centre.

24. The system as claimed in claim 22, wherein
the switch is configured to generate an electric signal for activating voice control when operated in the centre position for a first predetermined time.

25. The system as claimed in claim 24, wherein
the switch is configured to generate an electric signal for deactivating voice control when operated again in the centre position for the first predetermined time.

26. The system as claimed in claim 24, wherein
the control unit is configured to deactivate voice control when the switch is not operated for a second predetermined time.

27. The system as claimed in claim 24, wherein
the control unit is configured to deactivate voice control when the voice control is not used for a third predetermined time.

28. The system as claimed in claim 22, wherein
the switch is configured to generate an electric signal corresponding to a plurality of functions including accepting or rejecting incoming phone calls, changing volume or pausing music, navigating a screen installed in the vehicle and viewing stored documents in a storage device of the vehicle when operated in the forward, rear, left, right positions in a vehicle front-rear direction.

29. The system as claimed in claim 22, wherein
the control unit is configured to perform a predetermined function based on the corresponding electric signal generated by the switch.

30. The system as claimed in claim 22, wherein
the vehicle is a saddle type vehicle having the switch mounted on a handlebar of the saddle type vehicle.

31. The system as claimed in claim 22, wherein
the safety gear comprises a helmet to be worn by the rider.

32. The system as claimed in claim 22, wherein
the communication module and the voice input module communicate over a wireless network.

33. The system as claimed in claim 22, comprising
a display unit in communication with the control unit, the display unit configured to display a status upon activation of voice control.

34. A method for operating voice control for a vehicle, comprising:
actuating a switch;
generating an electric signal by the switch;
receiving the electric signal by a control unit; and
establishing communication between a communication module of the control unit and a voice input module disposed in a safety gear.

35. The method as claimed in claim 34, further comprising:
receiving an electric signal by the control unit corresponding to a position of the switch, the switch being configured to be actuated in forward, rear, left, right in a vehicle front-rear direction and centre positions.

36. The method as claimed in claim 35, further comprising:
generating an electric signal by the switch for activating voice control when operated in the centre position for a first predetermined time.

37. The method as claimed in claim 36, further comprising:
generating an electric signal by the switch for deactivating voice control when the switch is again operated in the centre position for the first predetermined time.

38. The method as claimed in claim 36, further comprising:
deactivating, by the control unit, voice control when the switch is not operated for a second predetermined time.

39. The method as claimed in claim 36, further comprising:
deactivating, by the control unit, voice control when the voice control is not used for a third predetermined time.

40. The method as claimed in claim 34, further comprising:
generating an electric signal by the switch corresponding to a plurality of functions including accepting or rejecting incoming phone calls, changing volume or pausing music, navigating a screen installed in the vehicle and viewing stored documents in a storage device of the vehicle when operated in the forward, rear, left, right positions in a vehicle front-rear direction.

41. The method as claimed in claim 34, further comprising:
displaying a status upon activation of voice control by a display unit, the display unit being in communication with the control unit.
